(19) United States
(12) Patent Application Publication
(10) Pub. No.: US 2003/0010903 A1
(43) Pub. Date: Jan. 16, 2003

(54) Power management system for scanner by detecting top cover thereof

(76) Inventor: Yu-Shuo Hsu, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/900,869

(22) Filed: Jul. 10, 2001

(51) Int. Cl. H01J 40/14

(52) U.S. Cl. 250/222.1

(57) ABSTRACT

A power management system for a scanner by detecting the opening or closing status of a top cover of the scanner is disclosed. The power management system includes a triggering member mounted at the bottom surface of the top cover which is mounted at the top surface of one lateral edge of the casing of the scanner. A detecting device arranged at the top plate of the casing and corresponding to the position of the triggering member. The detecting device is triggered by the triggering member when the top cover is opened and closed with respect to the top plate of the scanner, thereby controlling the power supply system of the scanner operated either in a standby mode or a regular power supplying mode.

### BACKGROUND OF THE INVENTION

1. Field of the Invention

The present invention relates to a power management system for a scanner, and in particular to a power management system for the scanner by detecting the opening or closing status of a top cover of the scanner. By means of the power management system, the power supply system of the scanner is operated either in standby mode or regular power supplying mode.

2. Description of the Prior Art

Scanners are widely used in office automation in scanning documents and images. The conventional scanner normally has a rectangular scanning window of appropriate size on the center region of a top plate of the casing of the scanner. A transparent glass is mounted to the scanning window to form a document positioning plate to support a document to be scanned. One lateral edge of the top surface of the casing is mounted with a top cover serving as a light masking plate. Typically, the top cover is pivotally mounted on the top plate of the scanner by a well known rotating shaft structure. In the process of images scanning, the top cover is covered on the document positioned on the document positioning plate.

To facilitate the operation of the scanning procedure, a plurality of switches and buttons are arranged on the panel of the scanner. During operation, a power source switch has to be switched on, and the top cover has to be opened to receive the document to be scanned, and then, the top cover is closed onto the top plate of the scanner. After that, the user of the scanner proceeds to operation by means of cable connection to computer devices. In typical operation of the scanner, majority of the conventional scanners are operated by the users in switching on/off of the power source switch of the scanner. This type of manual operation is inconvenient, and the user may forget switching off the power source switch. In addition, the frequent operations of the mechanical switches of the conventional scanner will cause malfunction to the switch.

Thus, it is desired to provide a power management system for the scanner to overcome the above discussed problems.

### SUMMARY OF THE INVENTION

Accordingly, it is an object of the present invention to provide a power management system for a scanner. By means of the power management system, a friendly operation interface between user and machine is provided to allow convenient utilization of the scanner and to simply operation procedure.

Yet another object of the present invention to provide a power management system for a scanner by detecting the opening or closing status of a top cover of the scanner.

To achieve the objects above, the power management system in accordance with a preferred embodiment of the present invention includes triggering member mounted at the bottom surface of the top cover which is mounted at the top surface of one lateral edge of the casing of the scanner. A detecting device arranged at the top plate of the casing and corresponding to the position of the triggering member. The detecting device is triggered by the triggering member when the top cover is opened and closed with respect to the top plate of the scanner, thereby controlling the power supply system of the scanner operated either in standby mode or regular power supplying mode. Preferably, the detecting device may be a photo detector including a light-emitting unit and a corresponding light-receiving unit. The detecting device may be a micro switch or a tact switch.

The present invention will be apparent to those skilled in the art by reading the following description of a preferred embodiment and the best mode of operation thereof with reference to the attached drawings, in which:

### BRIEF DESCRIPTION OF THE DRAWINGS

FIG. 1 is a perspective view showing a top cover is pivotally mounted on a scanner in accordance with a preferred embodiment of the present invention;

FIG. 2 is a perspective view showing the top cover is separated from the scanner of FIG. 1;

FIG. 3 is a sectional view taken along line 1-1 of FIG. 1.

FIG. 4 is a partial sectional view showing the relationship of the casing, top plate, top cover and the rotating shaft structure when the top cover is opened.

FIG. 5 is a partial sectional view showing the relationship of the casing, top plate, top cover and the rotating shaft structure when the top cover is closed.

FIG. 6 is an exploded view showing a photo detector serving as a detecting device is mounted on a bottom surface of the top plate of the scanner of the present invention;

FIG. 7 is an exploded view showing a micro switch serving as a detecting device is mounted on a bottom surface of the top plate of the scanner of the present invention;

FIG. 8 is an exploded view showing a tact switch serving as a detecting device is mounted on a bottom surface of the top plate of the scanner of the present invention; and

FIG. 9 is a control flow diagram of the present invention.

### DETAILED DESCRIPTION OF THE PREFERRED EMBODIMENTS

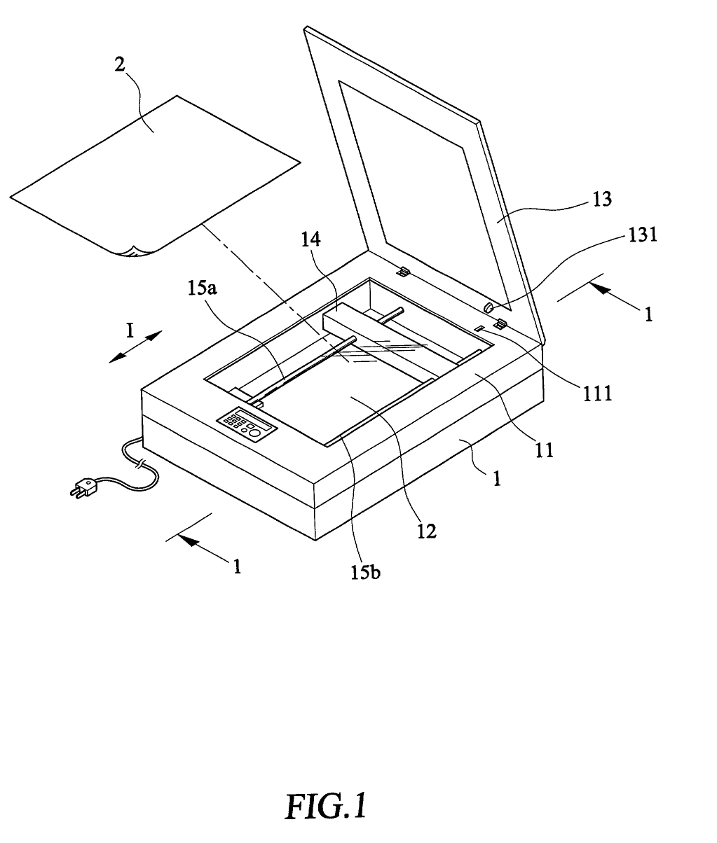

Referring to FIG. 1, there is shown a perspective view showing a top cover is pivotally mounted on a scanner in accordance with a preferred embodiment of the present invention. As shown in the figure, the center region of the top plate 11 of the casing 1 of the scanner is formed with a rectangular shape scanning window and the scanning window is mounted with a transparent glass to form a document positioning plate 12 for supporting a document 2 to be scanned. One side of the top surface of the casing 1 is pivotally mounted with a top cover 13 serving as a light masking plate by means of conventional rotating shaft structure 3. In scanning operation of the scanning device, the top cover 13 is covered on the document 2.

The interior of the scanning device is provided with a movable optical module 14 and a pair of guiding rods 15a, 15b. Under the driving of a well known driving mechanism (not shown) and a control circuit of the scanning device, the optical module 14 moves along the guiding rods 15a, 15b so that the document 2 on the document positioning plate 12 is scanned.

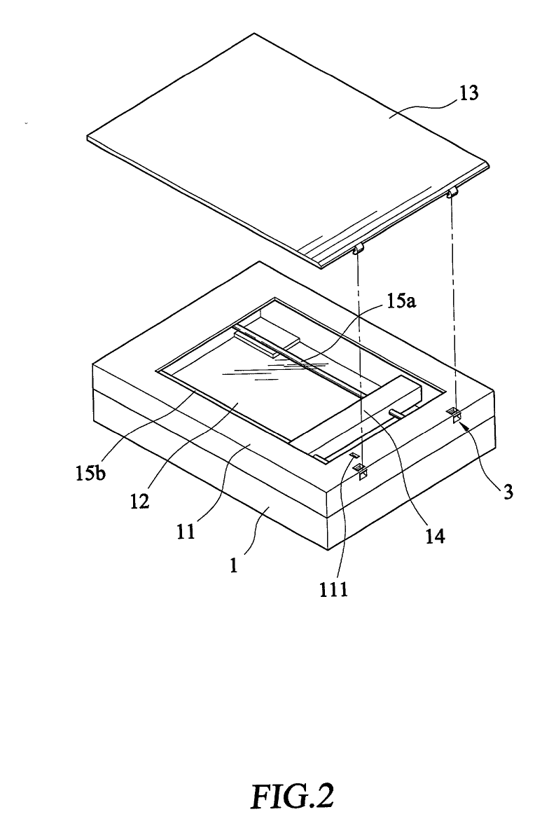

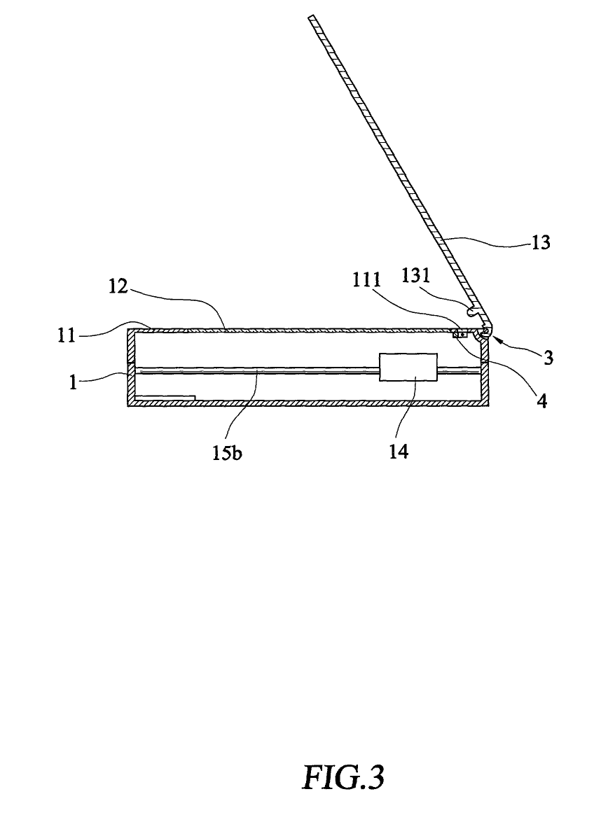

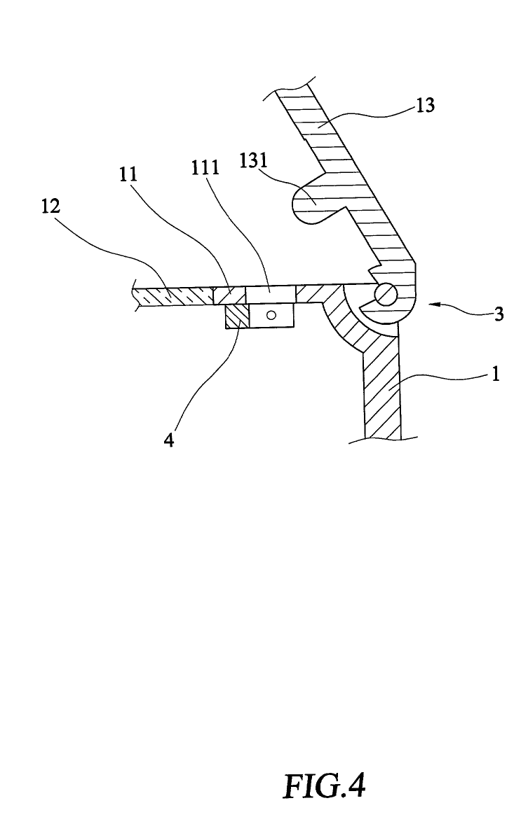

FIG. 2 is a perspective view showing the top cover 13 is separated from the casing 1 of the scanner of FIG. 1. FIG. 3 is a sectional view taken along line 1-1 of FIG. 1. FIG. 4 is a sectional view showing the relationship of the casing 1, the top plate 11, the top cover 13 and the rotating shaft structure 3 when the top cover 13 is opened.

As shown in the figures, the bottom surface of the top cover 13 is integrally joined with a downward protruded triggering member 131, so that the triggering member 131 moves simultaneously with the action of the top cover 13. In a preferred embodiment of the present invention, the triggering member 131 is a protruded section or protruded plate downwardly protruding out at an appropriate height.

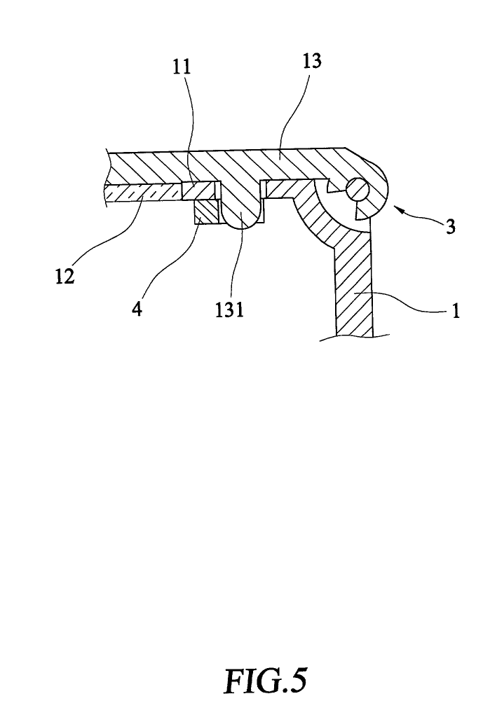

Further, a void region 111 is provided on the top plate 11 of the casing 1 of the scanner and is corresponding to the triggering member 131 of the top cover 13. The void region 111 allows the passing through of the triggering member 131 (as shown in FIG. 5) when the top cover 13 covers the top plate 11.

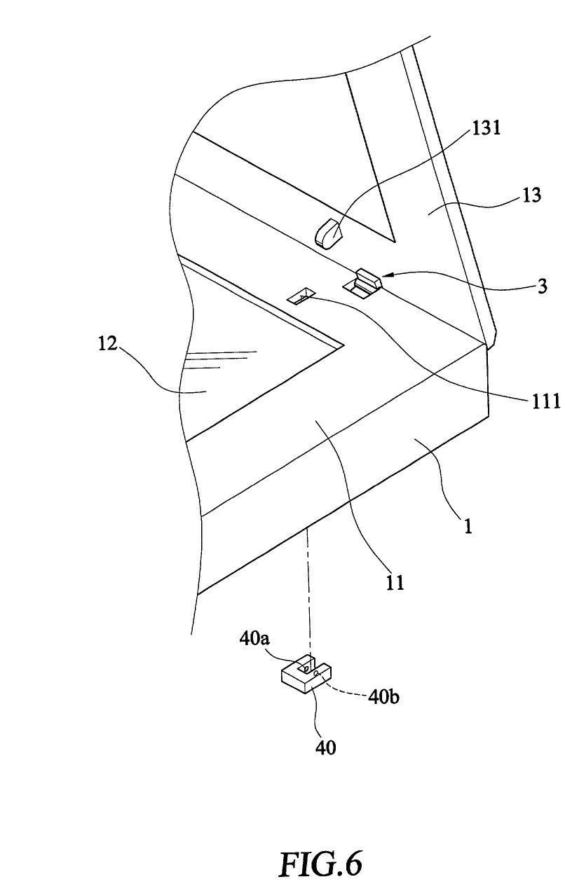

The top plate 11, corresponding to the bottom section of the void region 111, is mounted with a detecting device 4 which may be activated by the triggering member 131 to determine the opening or closing of the top cover 13. In the present preferred embodiment, the detecting device 4 is a switch element, which may be a photo detector 4a, as shown in FIG. 6. The photo detector 4a includes a light emitting unit 40a and a light receiving unit 40b. The blocking or unblocking of light of the light emitting unit 40a and the light receiving unit 40b by the triggering member 121 determines the closing or opening of the top cover 13.

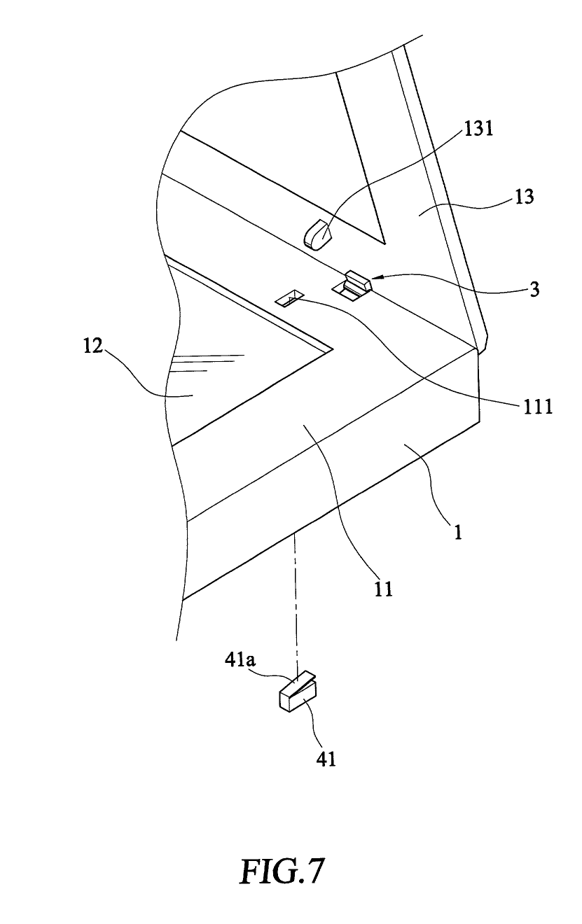

The detecting device 4 can be a micro switch 41, as shown in FIG. 7. The micro switch 41 is provided with an extended arm 41a. The triggering or non-triggering of the extended arm 41 a of the switch 41 by the triggering member 131 determines the closing or opening of the id 13.

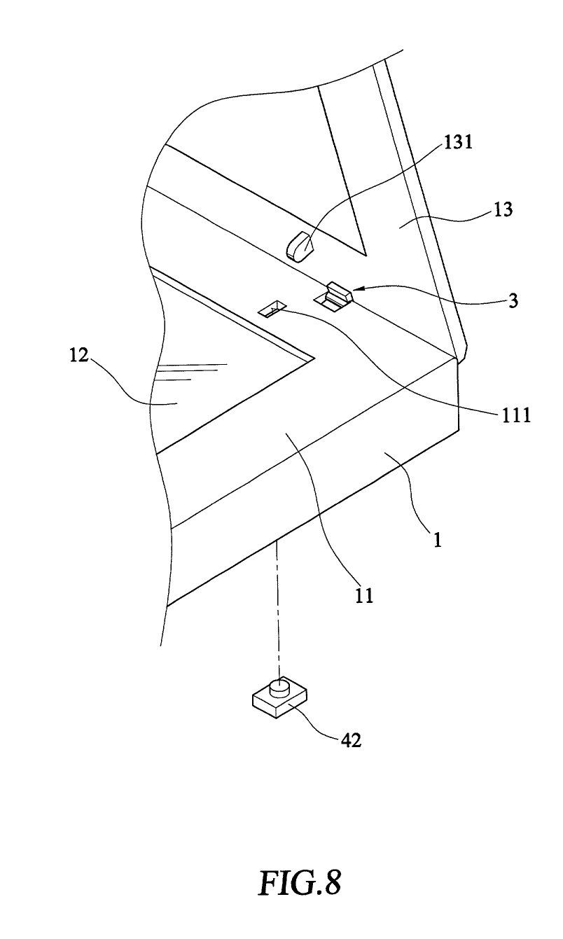

The detecting device 4 can be a tact switch 42, as shown in FIG. 8. The touching or non-touching of the tact switch 42 by the triggering member 131 determines the closing or opening of the top cover 13.

When the top cover 13 is opened from or closed onto the top plate 11 of the casing 1 of the scanner, the triggering member 131 triggers the detecting device 4. Then, the detecting device 4 is capable of generating a top cover-opening status signal to the controller of the scanner so as to control the supply or not of the power supply system of the scanner.

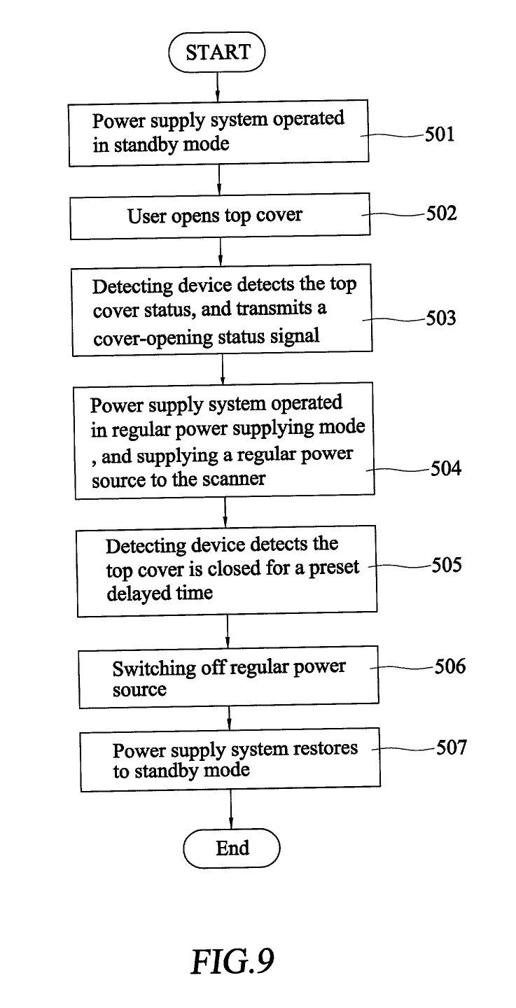

FIG. 9 is a control flow of a preferred embodiment of the present invention. At a normal status (closing of top cover), the power supply system of the scanner is operated in standby mode (step 501). If a user opens the top cover (step 502), the detecting device of the present invention detects the top cover status and a top cover-opening status signal is transmitted (step 503) to the control circuit of the scanner. At this instance, the control circuit commands the power supply system of the scanner operated in a regular power supplying mode to supply a regular power source to the scanner (step 504). After that, if the user closes the top cover (step 505), the detecting device detects the top cover-closing status and a top cover-closing status signal is transmitted to the control circuit. After a preset delayed time, the control circuit switches off the regular power source of the scanner (step 506). Then, the power supply system of the scanner restores to the standby mode (step 507).

Although the present invention has been described with reference to the preferred embodiments and the best mode of operation thereof, it is apparent to those skilled in the art that a variety of modifications and changes may be made without departing from the scope of the present invention which is intended to be defined by the appended claims.

1. A power management system for a scanner having a top plate with a void region and a top cover pivotally mounted on the top plate of the scanner, comprising:
a triggering member mounted on a bottom surface of the top cover with respect to the void region of the top plate; and
a detecting device arranged on a bottom surface of the top plate of the scanner, corresponding to the triggering member;
wherein the detecting device is triggered by the triggering member via the void region when the top cover is opened and closed with respect to the top plate of the scanner, so as to control a power supply system of the scanner operated either in a standby mode or a regular power supplying mode.

2. The power management system of claim 1, wherein the detecting device comprises a switch element mounted on the bottom surface of the top plate of the scanner, and the triggering member is a protruded section protruded from the bottom surface of the top cover, so that the triggering member triggers the switch element via the void region when the top cover covers on the top plate of the scanner.

3. The power management system of claim 2, wherein the switch element is a photo detector comprising a light-emitting unit and a corresponding light-receiving unit.

4. The power management system of claim 2, wherein the switch element is a micro switch provided with an extended arm engageable by the triggering element of the top cover.

5. The power management system of claim 2, wherein the switch element is a tact switch engageable by the triggering element of the top cover.
